(19) United States
(12) Patent Application Publication
(10) Pub. No.: US 2021/0150956 A1
(43) Pub. Date: May 20, 2021

(54) DISPLAY PANEL AND DISPLAY DEVICE

(71) Applicant: WUHAN CHINA STAR OPTOELECTRONICS TECHNOLOGY CO., LTD., Wuhan, Hubei (CN)

(72) Inventors: Yantao LU, Wuhan (CN); Guanghui LIU, Wuhan (CN); Chao WANG, Wuhan (CN)

(73) Assignee: WUHAN CHINA STAR OPTOELECTRONICS TECHNOLOGY CO., LTD., Wuhan, Hubei (CN)

(21) Appl. No.: 16/644,968

(22) PCT Filed: Dec. 4, 2019
(86) PCT No.: PCT/CN2019/122851

§ 371 Date: May 13, 2020

(30) Foreign Application Priority Data
Nov. 14, 2019 (CN) 201911109781.7

(51) Int. Cl. G09G 3/20

(52) U.S. Cl. CPC G09G 3/20; G09G 2310/0297; G09G 2300/0809; G09G 2300/0439; G09G 2300/0426

(57) ABSTRACT

The present invention provides a display panel and a display device. A displaying region in the display panel at least includes a first pixel unit column, a second pixel unit column adjacent thereto, and two data transfer lines. Each column of pixel units includes at least one pixel unit. Each pixel unit includes three sub-pixel units and a demultiplexer. The present invention, by disposing the demultiplexer in the pixel unit, saves the space of the lower border of the display panel and achieve a function of the demultiplexer is achieved.

The present invention claims the priority of a China patent application No. 201911109781.7 with a subject title of the invention “DISPLAY PANEL AND DISPLAY DEVICE”, which is filed on Nov. 14, 2019 with the China National Intellectual Property Administration (CNIDA), and contents of China patent application are integrated in the present invention by referring thereto.

### FIELD OF INVENTION

The present invention relates to a field of display technologies, especially relates to a display panel and a display device.

### BACKGROUND OF INVENTION

In a conventional display, a data driver chip outputs a pixel voltage to pixel units through data lines. Because the data lines in display have a great number, the corresponding data driver chip requires a great number of leads. To reduce a number of the data driver chip, related technologies dispose a demultiplexer (Demux) between the data driver chip and the data lines. However, because the display has a developing trend of a screen ratio, and a lower border of the display panel is required to be smaller. However, the display panel of the lower border of the demultiplexer occupies a great space in the lower border and hinders achievement of a high screen ratio of the display.

Therefore, the issue of the demultiplexer in the conventional display panel occupying the space of the lower border needs to be solved.

### SUMMARY OF INVENTION

The present invention provides a display panel and a display device to mitigate a technical issue that a demultiplexer in the conventional display panel occupies a space of the lower border.

To solve the above issue, technical solutions provided by the present invention are as follows.

The embodiment of the present invention provides a display panel, at least comprising, in a displaying region, a first pixel unit column, a second pixel unit column adjacent to the first pixel unit column, and two data transfer lines, wherein the first pixel unit column comprises; at least one first pixel unit each of which comprises three sub-pixel units and a first demultiplexer; wherein the second pixel unit column comprises at least one second pixel unit each of which comprises three sub-pixel units and a second demultiplexer; wherein each of the two data transfer lines is connected to corresponding ones of the sub-pixel units through the first demultiplexer or the second demultiplexer and is configured to provide the sub-pixel units with a pixel voltage; and wherein adjacent two of the sub-pixel units receive pixel voltages transferred by the data transfer lines respectively.

In the display panel provided by the embodiment of the present invention, each of the first demultiplexer and the second demultiplexer comprises three switching tubes, and the three switching tubes are disposed adjacent to the sub-pixel units of each of the at least one first pixel unit and the at least one second pixel unit.

In the display panel provided by the embodiment of the present invention, the switching tubes are field-effect transistors.

In the display panel provided by the embodiment of the present invention, the field-effect transistors are N-type field-effect transistors.

In the display panel provided by the embodiment of the present invention, the display panel further comprises at least three control signal lines, and the control signal lines are configured to control the switching tubes to switch on/off respectively.

In the display panel provided by the embodiment of the present invention, the first demultiplexer comprises a first switching tube, a second switching tube, and a third switching tube, a gate electrode of the first switching tube is connected to a first control signal line, a source electrode of the first switching tube is connected to a first data transfer line, a drain electrode of the first switching tube is connected to a first sub-pixel unit of the first pixel unit; a gate electrode of the second switching tube is connected to a second control signal line, a source electrode of the second switching tube is connected to a second data transfer line, a drain electrode of the second switching tube is connected to a second sub-pixel unit of the first pixel unit; a gate electrode of the third switching tube is connected to a third control signal line, and a source electrode of the third switching tube is connected to the first data transfer line, a drain electrode of the third switching tube is connected to a third sub-pixel unit of the first pixel unit.

In the display panel provided by the embodiment of the present invention, the second demultiplexer comprises a fourth switching tube, a fifth switching tube, and a sixth switching tube, a gate electrode of the fourth switching tube is connected to a first control signal line, a source electrode of the fourth switching tube is connected to a second data transfer line, a drain electrode of the fourth switching tube is connected to a first sub-pixel unit of the second pixel unit; a gate electrode of the fifth switching tube is connected to a second control signal line, a source electrode of the fifth switching tube is connected to a first data transfer line, a drain electrode of the fifth switching tube is connected to a second sub-pixel unit of the second pixel unit; a gate electrode of the sixth switching tube is connected to a third control signal line, a source electrode of the sixth switching tube is connected to the second data transfer line, a drain electrode of the sixth switching tube is connected to a third sub-pixel unit of the second pixel unit.

In the display panel provided by the embodiment of the present invention, a portion of each of the control signal lines is perpendicular to the data transfer lines, and another portion of each of the control signal lines is parallel to the data transfer lines.

In the display panel provided by the embodiment of the present invention, each of the control signal lines is perpendicular to the data transfer lines.

In the display panel provided by the embodiment of the present invention, the control signal lines and the data transfer lines are disposed in different layers, and the control signal lines are disposed above the data transfer lines.

The embodiment of the present invention also provides a display device, comprising a display panel, and the display panel at least comprising, in a displaying region, a first pixel unit column, a second pixel unit column adjacent to the first pixel unit column, and two data transfer lines, wherein the first pixel unit column comprises: at least one first pixel unit each of which comprises three sub-pixel units and a first demultiplexer; wherein the second pixel unit column comprises at least one second pixel unit each of which comprises three sub-pixel units and a second demultiplexer; wherein each of the two data transfer lines is connected to corresponding ones of the sub-pixel units through the first demultiplexer or the second demultiplexer and is configured to provide the sub-pixel units with a pixel voltage; and wherein adjacent two of the sub-pixel units receive pixel voltages transferred by the data transfer lines respectively.

In the display device provided by the embodiment of the present invention, each of the first demultiplexer and the second demultiplexer comprises three switching tubes, and the three switching tubes are disposed adjacent to the sub-pixel units of each of the at least one first pixel unit and the at least one second pixel unit.

In the display device provided by the embodiment of the present invention; the switching tubes are field-effect transistors.

In the display device provided by the embodiment of the present invention, the field-effect transistors are N-type field-effect transistors.

In the display device provided by the embodiment of the present invention, further comprising at least three control signal lines, the control signal lines are configured to control the switching tubes to switch on/off respectively.

In the display device provided by the embodiment of the present invention, the first demultiplexer comprises a first switching tube, a second switching tube, and a third switching tube, a gate electrode of the first switching tube is connected to a first control signal line, a source electrode of the first switching tube is connected to a first data transfer line, a drain electrode of the first switching tube is connected to a first sub-pixel unit of the first pixel unit; a gate electrode of the second switching tube is connected to a second control signal line, a source electrode of the second switching tube is connected to a second data transfer line, a drain electrode of the second switching tube is connected to a second sub-pixel unit of the first pixel unit; a gate electrode of the third switching tube is connected to a third control signal line, and a source electrode of the third switching tube is connected to the first data transfer line, a drain electrode of the third switching tube is connected to a third sub-pixel unit of the first pixel unit.

In the display device provided by the embodiment of the present invention, the second demultiplexer comprises a fourth switching tube, a fifth switching tube, and a sixth switching tube, a gate electrode of the fourth switching tube is connected to a first control signal line, a source electrode of the fourth switching tube is connected to a second data transfer line, a drain electrode of the fourth switching tube is connected to a first sub-pixel unit of the second pixel unit; a gate electrode of the fifth switching tube is connected to a second control signal line, a source electrode of the fifth switching tube is connected to a first data transfer line, a drain electrode of the fifth switching tube is connected to a second sub-pixel unit of the second pixel unit; a gate electrode of the sixth switching tube is connected to a third control signal line, a source electrode of the sixth switching tube is connected to the second data transfer line, a drain electrode of the sixth switching tube is connected to a third sub-pixel unit of the second pixel unit.

In the display device provided by the embodiment of the present invention, a portion of each of the control signal lines is perpendicular to the data transfer lines, and another portion of each of the control signal lines is parallel to the data transfer lines.

In the display device provided by the embodiment of the present invention, each of the control signal lines is perpendicular to the data transfer lines.

In the display device provided by the embodiment of the present invention, the control signal lines and the data transfer lines are disposed in different layers, and the control signal lines are disposed above the data transfer lines.

Advantages of the present invention are as follows: in the display panel and the display device provided by the present invention, the displaying region of the display panel at least comprises a first pixel unit column, a second pixel unit column adjacent thereto, and two data transfer lines. Each of the pixel unit columns comprises at least one pixel unit, and each pixel unit comprises three sub-pixel units and a demultiplexer. By disposing the demultiplexer in the pixel unit, the space of the lower border of the display panel is saved while a function of the demultiplexer is achieved, which increases a screen ratio of the display screen. Furthermore, control signal lines and data transfer lines of the demultiplexer are disposed in different layers, the control signal lines are disposed above of some of the data transfer lines, which reduces a loss of the pixel aperture ratio.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic view of a first connection relationship of pixel units of a display panel provided by an embodiment of the present invention.

FIG. 2 is a schematic view of a film structure of a first sub-pixel in a first pixel unit provided by the embodiment of the present invention.

FIG. 3 is a schematic view of a position of a first control line provided by the embodiment of the present invention.

FIG. 4 is a schematic view of a second connection relationship of the pixel unit of the display panel provided by the embodiment of the present invention.

### DETAILED DESCRIPTION OF PREFERRED EMBODIMENTS

Each of the following embodiments is described with appending figures to illustrate specific embodiments of the present invention that are applicable. The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention. In the figures, units with similar structures are marked with the same reference characters.

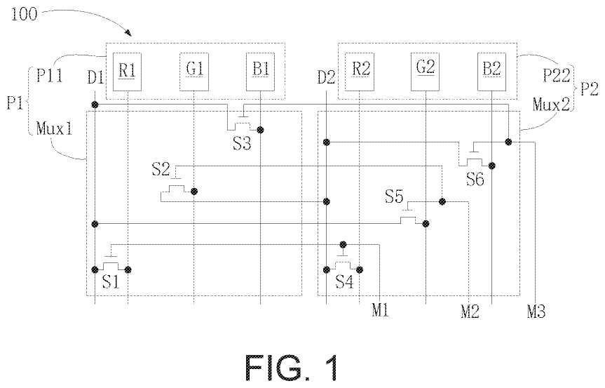

In an embodiment, with reference to FIG. 1, a display panel 100 is provided, a displaying region in the display panel 100 at least comprises a first pixel unit column, a second pixel unit column adjacent to the first pixel unit column, and two data transfer lines. The first pixel unit column comprises at least one first pixel unit P1, each of the at least one first pixel unit P1 comprises three sub-pixel units P11 (R1, G1, B1 in FIG. 1) and a first demultiplexer Mux1. The second pixel unit column comprises at least one second pixel unit P2, and each of the at least one second pixel unit P2 comprises three sub-pixel units P22 (R2, G2, B2 in FIG. 1) and a second demultiplexer Mux2. The two data transfer lines are connected to corresponding sub-pixel units respectively through the first demultiplexer Mux1 or the second demultiplexer Mux2, and are configured to provide the sub-pixel units with pixel voltages, Adjacent two of the sub-pixel units receive pixel voltages transferred by the data transfer lines respectively.

Specifically, each of the first demultiplexer Mux1 and the second demultiplexer Mux2 comprises three switching tubes, and the three switching tubes are disposed adjacent to the sub-pixel units of each of the at least one first pixel unit and the at least one second pixel unit.

In the embodiment of the present invention, by disposing the demultiplexer in the pixel unit, the space of the lower border of the display panel is saved while a function of the demultiplexer is achieved, which increases a screen ratio of the display screen.

In an embodiment, with reference to FIG. 1, the display panel 100 further comprises three control signal lines (M1, M2, M3 in FIG. 1), and the control signal lines are configured to control the switching tubes to switch on/off respectively.

Specifically, the first demultiplexer Mux1 in the first pixel unit P1 comprises a first switching tube S1, a second switching tube S2, and a third switching tube S3. The first switching tube S1 is configured to control a first sub-pixel unit R1 of the first pixel unit P1 to switch on/off, the second switching tube S2 is configured to control a second sub-pixel unit G1 of the first pixel unit P1 to switch on/off, the third switching tube S3 is configured to control a third sub-pixel unit B1 of the first pixel unit P1 to switch on/off.

Furthermore, the second demultiplexer Mux2 in the second pixel unit P2 comprises a fourth switching tube S4, a fifth switching tube S5, and a sixth switching tube S6. The fourth switching tube S4 is configured to control a first sub-pixel unit R2 of the second pixel unit P2 to switch on/off. The fifth switching tube S5 is configured to control a second sub-pixel unit G2 of the second pixel unit P2 to switch on/off. The sixth switching tube S6 is configured to control a third sub-pixel unit B2 of the second pixel unit P2 to switch on/off.

Furthermore, the three control signal lines are a first control signal line M1, a second control signal line M2, and a third control signal line M3. The first control signal line M1 is connected to the first switching tube S1 and a control terminal of the fourth switching tube S4. The second control signal line M2 is connected to the second switching tube S2 and a control terminal of the fifth switching tube S5. The third control signal line M3 is connected to the third switching tube S3 and a control terminal of the sixth switching tube S6.

Furthermore, the two data transfer lines in the displaying region of the display panel 100 are a first data transfer line D1 and a second data transfer line D2. The first data transfer line D1 is connected to an input terminal of the first switching tube S1, an input terminal of the third switching tube S3, and an input terminal of the fifth switching tube S5. The second data transfer line D2 is connected to an input terminal of the second switching tube S2, an input terminal of the fourth switching tube S4, and an input terminal of the sixth switching tube S6.

Specifically, the two data transfer lines provide the sub-pixel units with pixel voltages through the switching tube of the first demultiplexer Mux1 or the second demultiplexer Mux2. The input terminals of adjacent two of the switching tubes are connected different ones of the data transfer lines respectively such that, the adjacent sub-pixel units acquire different pixel voltages respectively.

Furthermore, the first switching tube S1, the second switching tube S2, the third switching tube S3, the fourth switching tube S4, the fifth switching tube S5, and the sixth switching tube S6 are N-type field-effect transistors.

Specifically, a gate electrode of the first switching tube S1 is connected to the first control signal line M1, a source electrode of the first switching tube S1 is connected to the first data transfer line D1, and a drain electrode of the first switching tube S1 is connected to the first sub-pixel unit R1 of the first pixel unit P1. A gate electrode of the second switching tube S2 is connected to the second control signal line M2, a source electrode of the second switching tube S2 is connected to the second data transfer line D2, and a drain electrode of the second switching tube S2 is connected to the second sub-pixel unit G1 of the first pixel unit P1. A gate electrode of the third switching tube S3 is connected to the third control signal line M3, a source electrode of the third switching tube S3 is connected to the first data transfer line D1, and a drain electrode of the third switching tube S3 is connected to the third sub-pixel unit B1 of the first pixel unit P1. A gate electrode of the fourth switching tube S4 is connected to the first control signal line M1, a source electrode of the fourth switching tube S4 is connected to the second data transfer line D2, and a drain electrode of the fourth switching tube S4 is connected to the first sub-pixel unit R2 of the second pixel unit P2. A gate electrode of the fifth switching tube S5 is connected to the second control signal line M2, a source electrode of the fifth switching tube S5 is connected to the first data transfer line D1, a drain electrode of the fifth switching tube S5 is connected to the second sub-pixel unit G2 of the second pixel unit P2. A gate electrode of the sixth switching tube S6 is connected to the third control signal line M3, a source electrode of the sixth switching tube S6 is connected to the second data transfer line D2, a drain electrode of the sixth switching tube S6 is connected to the third sub-pixel unit B2 of the second pixel unit P2.

Specifically, when the sub-pixel units are required to switch on, corresponding ones of the control signal lines provide the gate electrodes of the switching tubes with control signals to make source or drain electrodes of the switching tubes to switch on. Thus, data signals of the data transfer lines of the source electrode can be transferred to the sub-pixel units through drain electrode.

Furthermore, the first control signal line M1, wiring eules of the second control signal line M2 and the third control signal line M3 are consistent. Taking the first control signal line M1 as an example, with reference to FIG. 1 a portion of the first control signal line M1 is perpendicular to the first data transfer line D1 (first data transfer line D1 is parallel to the second data transfer line D2, description here takes the first data transfer line D1 as an example for convenience), another portion of the first control signal line M1 is parallel to the first data transfer line D1. Furthermore, the first control signal line M1 and the data transfer lines are disposed in different layers, the first control signal line M1 is connected to the gate electrodes of the switching tubes through via holes. In the meantime, the first control signal line M1 is disposed opposite to wires of the data transfer lines, the gate electrode scan lines, or the source electrodes of the switching tubes to reduce loss of the pixel aperture ratio. Specifically, the first control signal M1 is disposed above wires of the source electrodes of the switching tubes to reduce loss of the pixel aperture ratio.

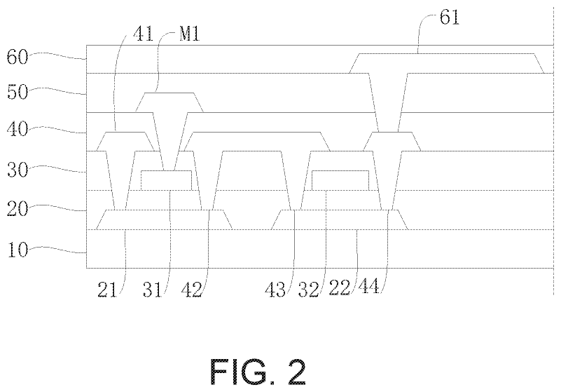

Specifically, a film structure of the first sub-pixel unit of the first pixel unit is taken as an example, with reference to the schematic view of the film structure in FIG. 2, the film structure comprises an active layer 20, a first metal layer 30, a second metal layer 40, a third metal layer 50, a pixel electrode layer 60, and insulation layers (not shown in FIG. 2) disposed between the above layers that are stacked on the substrate 10.

Specifically, with reference to FIG. 2, the active layer 20 is patterned to form a first active region 21 and a second active region 22. The first metal layer 30 is patterned to form a first gate electrode 31 and a second gate electrode 32. The second metal layer 40 is patterned to form a first source electrode 41, a first drain electrode 42, a second source electrode 43, and a second drain electrode 44. The third metal layer 50 is patterned to form the first control signal line M1. The pixel electrode layer 60 is patterned to form a pixel electrode 61. The first active region 21, the first gate electrode 31, the first source electrode 41, and the first drain electrode 42 form a first switching tube, and the second active region 22, the second gate electrode 32, the second source electrode 43, and the second drain electrode 44 form a switching tube of the first sub-pixel.

Specifically, the first source electrode 41 of the first switching tube is connected to the data transfer lines (not shown in FIG. 2); the first drain electrode 42 is connected to the second source electrode 43, the second drain electrode 44 is connected to the pixel electrode 61. The first gate electrode 32 is connected to the first control signal line M1 through a via hole.

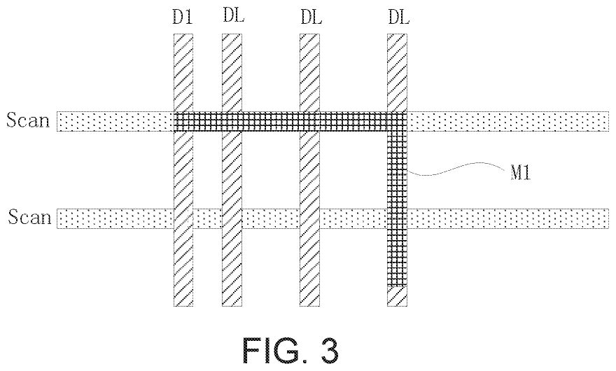

Furthermore, with reference to FIG. 3, a portion of the first control signal line M1 perpendicular to the first data transfer line D1 is disposed on a gate electrode scan line Scan, a portion of the first control signal line M1 parallel to the first data transfer line D1 is disposed above a data line DL of a source and drain electrode layer to reduce a loss of the pixel aperture ratio.

Furthermore, the third metal layer and the pixel electrode layer can also be disposed in the same layer. Specific embodiments refer to the above embodiment and will not be described repeatedly herein.

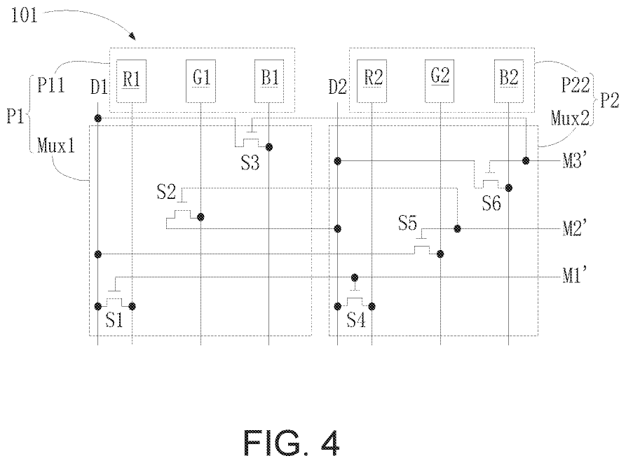

In another embodiment, with reference to a schematic view of a connection relationship of the pixel unit of the display panel 101 in FIG. 4. A difference thereof from the above embodiment is that in the displaying region pixel unit, the control signal lines (M1′, M2′, M3′ in FIG. 4) is disposed perpendicular to the data transfer lines (D1, D2 in FIG. 4), and is disposed above the gate electrode scan line. Specific embodiments refer to the above embodiment, and will not be described repeatedly herein.

In an embodiment, a display device is provided and comprises a display panel, and the display panel at least comprises, in a displaying region, a first pixel unit column, a second pixel unit column adjacent to the first pixel unit column, and two data transfer lines, wherein the first pixel unit column comprises; at least one first pixel unit each of which comprises three sub-pixel units and a first demultiplexer; wherein the second pixel unit column comprises at least one second pixel unit each of which comprises three sub-pixel units and a second demultiplexer; wherein each of the two data transfer lines is connected to corresponding ones of the sub-pixel units through the first demultiplexer or the second demultiplexer and is configured to provide the sub-pixel units with a pixel voltage; and wherein adjacent two of the sub-pixel units receive pixel voltages transferred by the data transfer lines respectively.

Specifically, each of the first demultiplexer and the second demultiplexer comprises three switching tubes, and the three switching tubes are disposed adjacent to the sub-pixel units of each of the at least one first pixel unit and the at least one second pixel unit.

Furthermore; the switching tubes are field-effect transistors.

Furthermore, the field-effect transistor are N-type field-effect transistor.

Furthermore, the display panel further comprises at least three control signal lines, and the control signal lines are configured to control the switching tubes to switch on/off respectively.

Specifically, the first demultiplexer comprises a first switching tube, a second switching tube, and a third switching tube, a gate electrode of the first switching tube is connected to a first control signal line, a source electrode of the first switching tube is connected to a first data transfer line, a drain electrode of the first switching tube is connected to a first sub-pixel unit of the first pixel unit; a gate electrode of the second switching tube is connected to a second control signal line, a source electrode of the second switching tube is connected to a second data transfer line, a drain electrode of the second switching tube is connected to a second sub-pixel unit of the first pixel unit; a gate electrode of the third switching tube is connected to a third control signal line, and a source electrode of the third switching tube is connected to the first data transfer line, a drain electrode of the third switching tube is connected to a third sub-pixel unit of the first pixel unit.

Specifically, the second demultiplexer comprises a fourth switching tube, a fifth switching tube, and a sixth switching tube, a gate electrode of the fourth switching tube is connected to a first control signal line, a source electrode of the fourth switching tube is connected to a second data transfer line, a drain electrode of the fourth switching tube is connected to a first sub-pixel unit of the second pixel unit; a gate electrode of the fifth switching tube is connected to a second control signal line, a source electrode of the fifth switching tube is connected to a first data transfer line; a drain electrode of the fifth switching tube is connected to a second sub-pixel unit of the second pixel unit; a gate electrode of the sixth switching tube is connected to a third control signal line, a source electrode of the sixth switching tube is connected to the second data transfer line, a drain electrode of the sixth switching tube is connected to a third sub-pixel unit of the second pixel unit.

Furthermore, a portion of each of the control signal lines is perpendicular to the data transfer lines, and another portion of each of the control signal lines is parallel to the data transfer lines.

Furthermore, each of the control signal lines is perpendicular to the data transfer lines.

Furthermore, the control signal lines and the data transfer lines are disposed in different layers, and the control signal lines are disposed above the data transfer lines.

According to the above embodiment:

In the display panel and the display device provided by the present invention, the displaying region of the display panel at least comprises a first pixel unit column, a second pixel unit column adjacent thereto, and two data transfer lines. Each of the pixel unit columns comprises at least one pixel unit, and each pixel unit comprises three sub-pixel units and a demultiplexer. By disposing the demultiplexer in the pixel unit, the space of the lower border of the display panel is saved while a function of the demultiplexer is achieved, which increases a screen ratio of the display screen. Furthermore, control signal lines and data transfer lines of the demultiplexer are disposed in different layers, the control signal lines are disposed above of some of the data transfer lines, which reduces a loss of the pixel aperture ratio.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

1. A display panel, comprising, in a displaying region, a first pixel unit column, a second pixel unit column adjacent to the first pixel unit column, and two data transfer lines, wherein the first pixel unit column comprises: at least one first pixel unit each of which comprises three sub-pixel units and a first demultiplexer;
wherein the second pixel unit column comprises at least one second pixel unit each of which comprises three sub-pixel units and a second demultiplexer;
wherein each of the two data transfer lines is connected to corresponding ones of the sub-pixel units through the first demultiplexer or the second demultiplexer and is configured to provide the sub-pixel units with a pixel voltage; and
wherein adjacent two of the sub-pixel units receive pixel voltages transferred by the data transfer lines respectively;
wherein each of the first demultiplexer and the second demultiplexer comprises three switching tubes, and the three switching tubes are disposed adjacent to the sub-pixel units of each of the at least one first pixel unit and the at least one second pixel unit;
wherein at least three control signal lines are configured to control the switching tubes to switch on/off respectively; and
wherein the control signal lines and the data transfer lines are disposed in different layers, and the control signal lines are disposed above the data transfer lines.

2. (canceled)

3. The display panel as claimed in claim 1, wherein the switching tubes are field-effect transistors.

4. The display panel as claimed in claim 3, wherein the field-effect transistors are N-type field-effect transistors.

5. (canceled)

6. The display panel as claimed in claim 1, wherein the first demultiplexer comprises a first switching tube, a second switching tube, and a third switching tube, a gate electrode of the first switching tube is connected to a first control signal line, a source electrode of the first switching tube is connected to a first data transfer line, a drain electrode of the first switching tube is connected to a first sub-pixel unit of the first pixel unit; a gate electrode of the second switching tube is connected to a second control signal line, a source electrode of the second switching tube is connected to a second data transfer line, a drain electrode of the second switching tube is connected to a second sub-pixel unit of the first pixel unit; a gate electrode of the third switching tube is connected to a third control signal line, and a source electrode of the third switching tube is connected to the first data transfer line, a drain electrode of the third switching tube is connected to a third sub-pixel unit of the first pixel unit.

7. The display panel as claimed in claim 1, wherein the second demultiplexer comprises a fourth switching tube, a fifth switching tube, and a sixth switching tube, a gate electrode of the fourth switching tube is connected to a first control signal line, a source electrode of the fourth switching tube is connected to a second data transfer line, a drain electrode of the fourth switching tube is connected to a first sub-pixel unit of the second pixel unit; a gate electrode of the fifth switching tube is connected to a second control signal line, a source electrode of the fifth switching tube is connected to a first data transfer line, a drain electrode of the fifth switching tube is connected to a second sub-pixel unit of the second pixel unit; a gate electrode of the sixth switching tube is connected to a third control signal line, a source electrode of the sixth switching tube is connected to the second data transfer line, a drain electrode of the sixth switching tube is connected to a third sub-pixel unit of the second pixel unit.

8. The display panel as claimed in claim 1, wherein a portion of each of the control signal lines is perpendicular to the data transfer lines, and another portion of each of the control signal lines is parallel to the data transfer lines.

9. The display panel as claimed in claim 1, wherein each of the control signal lines is perpendicular to the data transfer lines.

10. (canceled)

11. A display device, comprising a display panel, and the display panel comprising, in a displaying region, a first pixel unit column, a second pixel unit column adjacent to the first pixel unit column, and two data transfer lines, wherein the first pixel unit column comprises: at least one first pixel unit each of which comprises three sub-pixel units and a first demultiplexer;
wherein the second pixel unit column comprises at least one second pixel unit each of which comprises three sub-pixel units and a second demultiplexer;
wherein each of the two data transfer lines is connected to corresponding ones of the sub-pixel units through the first demultiplexer or the second demultiplexer and is configured to provide the sub-pixel units with a pixel voltage; and
wherein adjacent two of the sub-pixel units receive pixel voltages transferred by the data transfer lines respectively;
wherein each of the first demultiplexer and the second demultiplexer comprises three switching tubes, and the three switching tubes are disposed adjacent to the sub-pixel units of each of the at least one first pixel unit and the at least one second pixel unit;
wherein at least three control signal lines are configured to control the switching tubes to switch on/off respectively; and
wherein the control signal lines and the data transfer lines are disposed in different layers, and the control signal lines are disposed above the data transfer lines.

12. (canceled)

13. The display device as claimed in claim 11, wherein the switching tubes are field-effect transistors.

14. The display device as claimed in claim 13, wherein the field-effect transistors are N-type field-effect transistors.

15. (canceled)

16. The display device as claimed in claim 11, wherein the first demultiplexer comprises a first switching tube, a second switching tube, and a third switching tube, a gate electrode of the first switching tube is connected to a first control signal line, a source electrode of the first switching tube is connected to a first data transfer line, a drain electrode of the first switching tube is connected to a first sub-pixel unit of the first pixel unit; a gate electrode of the second switching tube is connected to a second control signal line, a source electrode of the second switching tube is connected to a second data transfer line, a drain electrode of the second switching tube is connected to a second sub-pixel unit of the first pixel unit; a gate electrode of the third switching tube is connected to a third control signal line, and a source electrode of the third switching tube is connected to the first data transfer line, a drain electrode of the third switching tube is connected to a third sub-pixel unit of the first pixel unit.

17. The display device as claimed in claim 11, wherein the second demultiplexer comprises a fourth switching tube, a fifth switching tube, and a sixth switching tube, a gate electrode of the fourth switching tube is connected to a first control signal line, a source electrode of the fourth switching tube is connected to a second data transfer line, a drain electrode of the fourth switching tube is connected to a first sub-pixel unit of the second pixel unit; a gate electrode of the fifth switching tube is connected to a second control signal line, a source electrode of the fifth switching tube is connected to a first data transfer line, a drain electrode of the fifth switching tube is connected to a second sub-pixel unit of the second pixel unit; a gate electrode of the sixth switching tube is connected to a third control signal line, a source electrode of the sixth switching tube is connected to the second data transfer line, a drain electrode of the sixth switching tube is connected to a third sub-pixel unit of the second pixel unit.

18. The display device as claimed in claim 11, wherein a portion of each of the control signal lines is perpendicular to the data transfer lines, and another portion of each of the control signal lines is parallel to the data transfer lines.

19. The display device as claimed in claim 11, wherein each of the control signal lines is perpendicular to the data transfer lines.

20. (canceled)
